(19) United States
(12) Patent Application Publication
(10) Pub. No.: US 2025/0296550 A1
(43) Pub. Date: Sep. 25, 2025

(54) VEHICLE SURROUNDING VIDEO DISPLAY DEVICE

(71) Applicant: TOYOTA JIDOSHA KABUSHIKI KAISHA, Toyota-shi (JP)

(72) Inventor: Hiroyuki TACHIBANA, Okazaki-shi (JP)

(73) Assignee: TOYOTA JIDOSHA KABUSHIKI KAISHA, Toyota-shi (JP)

(21) Appl. No.: 18/989,742

(22) Filed: Dec. 20, 2024

(30) Foreign Application Priority Data
Mar. 21, 2024 (JP) 2024-044943

(51) Int. Cl. B60W 30/06; B60R 1/23; B60W 50/00

(52) U.S. Cl. CPC B60W 30/06; B60R 1/23; B60W 50/0097; B60R 2300/10; B60R 2300/20; B60R 2300/30; B60R 2300/806; B60W 2420/403

(57) ABSTRACT

A vehicle surrounding video display device, which displays a peripheral image of a vehicle capable of automatically performing automatic parking control for automatically entering a vehicle into a predetermined parking space or automatically leaving a parking space, includes a video generation unit capable of generating a plurality of peripheral images having different viewpoints based on an image captured by a camera mounted on the vehicle, and a video display control unit that selects a peripheral image corresponding to the progress of the automatic parking control from the plurality of peripheral images that can be generated by the video generation unit during execution of the automatic parking control, and displays the peripheral image on a display device of the vehicle.

### CROSS-REFERENCE TO RELATED APPLICATION

This application claims priority to Japanese Patent Application No. 2024-044943 filed on Mar. 21, 2024, incorporated herein by reference in its entirety.

### BACKGROUND

### 1. Technical Field

The present disclosure relates to a vehicle surrounding video display device.

### 2. Description of Related Art

For example, Japanese Unexamined Patent Application Publication No. 2015-076645 (JP 2015-076645 A) discloses a vehicle surroundings display device in which, when displaying a bird's-eye view image around a host vehicle on a touch panel of a navigation device mounted on the host vehicle, a display area of the bird's-eye view image is changed according to a traveling direction of the host vehicle.

### SUMMARY

In recent years, a parking assistance system capable of executing automatic parking in which a vehicle is autonomously driven to enter or leave a predetermined parking slot has been put into practical use. Information that the driver wants to know during execution of such automatic parking (for example, a vehicle surrounding video displayed on a display device) changes according to the progress of the automatic parking. In the technology described in JP 2015-076645 A, only the display area of the bird's-eye view image is changed. Therefore, there is a possibility that the information that the driver wants to know cannot be provided accurately.

The present disclosure provides a technology capable of effectively displaying a surrounding video according to the progress of automatic parking.

A vehicle surrounding video display device according to the present disclosure is
a vehicle surrounding video display device configured to display a surrounding video around a vehicle configured to execute automatic parking control for causing the vehicle to automatically enter a predetermined parking slot or automatically leave the parking slot. The vehicle surrounding video display device includes:
a video generator configured to generate a plurality of surrounding videos having different viewpoints based on an image captured by a camera mounted on the vehicle; and
a video display controller configured to select a surrounding video corresponding to progress of the automatic parking control from among the plurality of surrounding videos generable by the video generator during execution of the automatic parking control, and display the surrounding video on a display device of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a hardware configuration of a vehicle according to the present embodiment;

FIG. 2 is a schematic diagram illustrating a software configuration of the control device according to the present embodiment;

FIG. 3 is a schematic diagram illustrating an example of a target movement path set by the automatic parking control unit according to the present embodiment;

FIG. 4 is a schematic diagram illustrating an example of a first bird's-eye view image generated by the peripheral image generation unit according to the present embodiment and a camera viewpoint image in front of the vehicle;

FIG. 5 is a schematic diagram illustrating an example of a second bird's-eye view image generated by the peripheral image generation unit according to the present embodiment and a camera viewpoint image behind the vehicle;

FIG. 6 is a schematic diagram illustrating an example of a third bird's-eye view image generated by the peripheral image generation unit according to the present embodiment and a virtual viewpoint image in which the vehicle is viewed from above obliquely to the right front;

FIG. 7 is a schematic diagram illustrating a fourth bird's-eye view image generated by the peripheral image generation unit according to the present embodiment, and an exemplary virtual viewpoint image in which the vehicle is viewed from above obliquely behind the left side; and

FIG. 8 is a flowchart for explaining a routine of processing of the peripheral video display control according to the present embodiment.

### DETAILED DESCRIPTION OF EMBODIMENTS

Hereinafter, a vehicle surrounding video display device according to the present embodiment will be described with reference to the drawings.

### Hardware Configuration

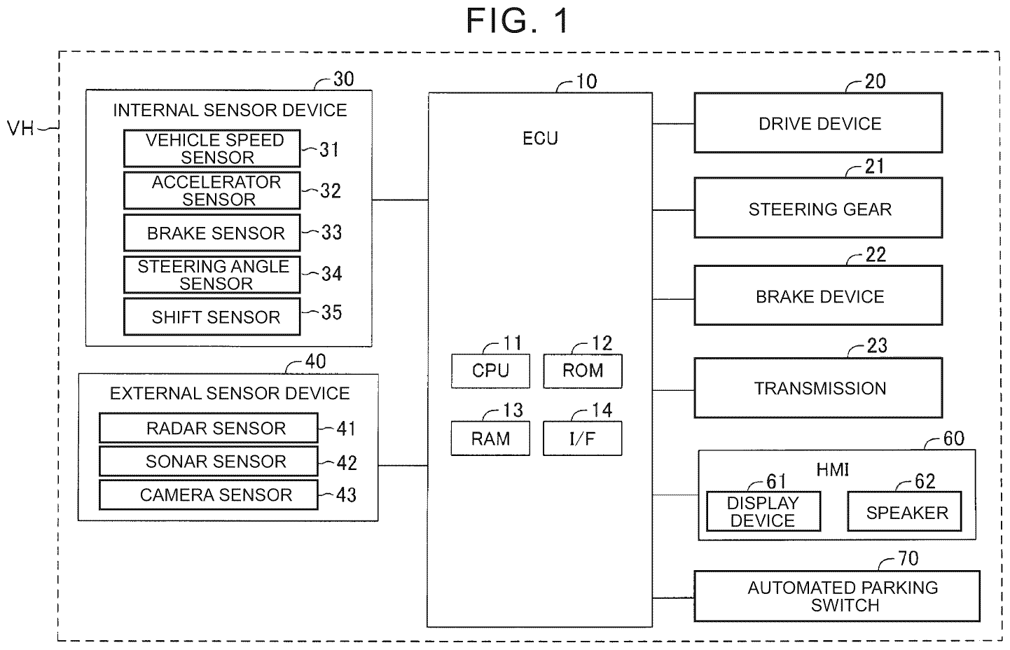

FIG. 1 is a schematic diagram illustrating a hardware configuration of a vehicle VH according to the present embodiment. In the following description, the vehicle VH may be referred to as an own vehicle when it needs to be distinguished from other vehicles or the like.

The vehicle VH has an ECU (Electronic Control Unit) 10. ECU 10 includes CPU (Central Processing Unit) 11, ROM (Read Only Memory) 12, RAM (Random Access Memory) 13, and interface device 14. CPU 11 is a processor that executes various programs stored in ROM 12. ROM 12 is a non-volatile memory that stores data and the like required for CPU 11 to execute various programs. RAM 13 provides a working area to be deployed when various programs are executed by CPU 11. The interface device 14 is a communication device for communicating with an external device.

ECU 10 is an automatic warehousing control for automatically storing the vehicle VH in a predetermined parking compartment, and a control device for performing automatic warehousing control for automatically unloading the vehicle VH from the predetermined parking compartment. Hereinafter, the automatic warehousing control and the automatic warehousing control may be collectively referred to as “automatic parking control”. A drive device 20, a steering device 21, a braking device 22, a transmission 23, an internal sensor device 30, an external sensor device 40, an HMI (Human Machine Interface) 60, an automated parking switch 70, and the like are communicably connected to ECU 10.

The drive device 20 generates a driving force to be transmitted to the driving wheels of the vehicle VH. Examples of the drive device 20 include an electric motor and an engine. In the present embodiment, the vehicle VH may be any of a hybrid electric vehicle (HEV), a plug-in Hybrid vehicle (PHEV), a fuel cell electric vehicle (FCEV), a battery electric vehicle (BEV), and an engine-driven vehicle. The steering device 21 applies a steering force to the wheels of the vehicle VH. The braking device 22 applies a braking force to the wheels of the vehicle VH. The transmission 23 is configured to be selectively switchable to a parking range that locks the rotation of the drive wheels, a reverse range that causes the vehicle VH to travel backward, a neutral range that blocks the transmission of power, and a drive range that causes the vehicle VH to travel forward.

The internal sensor device 30 is a sensor that detects the condition of the vehicle VH. Specifically, the internal sensor device 30 includes a vehicle speed sensor 31, an accelerator sensor 32, a brake sensor 33, a steering angle sensor 34, a shift sensor 35, and the like. The vehicle speed sensor 31 detects the traveling speed of the vehicle VH, that is, the vehicle speed. The accelerator sensor 32 detects an operation amount of an accelerator pedal (not shown) by a driver. The brake sensor 33 detects an operation amount of a brake pedal (not shown) by the driver. The steering angle sensor 34 detects a rotation angle of a steering wheel or a steering shaft (not shown), that is, a steering angle. The shift sensor 35 detects a shift position (parking P, reverse R, neutral N, drive D, and the like) of the transmission 23. The internal sensor device 30 transmits the condition of the vehicle VH detected by the sensors 31 to 35 to ECU 10 at a predetermined cycle.

The external sensor device 40 is an example of an obstacle detector of the present disclosure, and is a sensor that recognizes target information related to a target in the vicinity of a vehicle VH. Specifically, the external sensor device 40 includes a radar sensor 41, a sonar sensor 42, a camera sensor 43, and the like.

The radar sensor 41 includes a front radar sensor that recognizes the front of the vehicle VH, a rear radar sensor that recognizes the rear of the vehicle VH, a left side radar sensor that recognizes the left side of the vehicle VH, a right side radar sensor that recognizes the right side of the vehicle VH, and the like. The radar sensor 41 includes a millimeter wave radar and/or a lidar. The millimeter-wave radar radiates a radio wave in a millimeter-wave band, and receives a reflected wave reflected by a target existing in the radiation range, thereby obtaining a relative distance, a relative velocity, and the like between the vehicle VH and the target. The lidar sequentially scans the pulsed laser beam having a wavelength shorter than the millimeter wave toward a plurality of directions, and receives the reflected light reflected by the target, thereby obtaining a shape of the target, a relative distance between the vehicle VH and the target, a relative velocity, and the like.

The sonar sensor 42 includes a front sonar sensor that recognizes the front of the vehicle VH, a rear sonar sensor that recognizes the rear of the vehicle VH, a left side sonar sensor that recognizes the left side of the vehicle VH, a right side sonar sensor that recognizes the right side of the vehicle VH, and the like. The sonar sensor 42 emits an ultrasonic wave and receives a reflected wave reflected by a target existing in the emission area, thereby obtaining a relative distance, a relative velocity, and the like between the 10 vehicle VH and the target.

The camera sensor 43 includes a front camera sensor that captures an image of the front of the vehicle VH, a rear camera sensor that captures an image of the rear of the vehicle VH, a left side camera sensor that captures an image of the left side of the vehicle VH, a right side camera sensor that captures an image of the right side of the vehicle VH, and the like. The camera sensor 43 is, for example, a stereo camera or a monocular camera, and a digital camera having an image sensor such as a CMOS or a CCD can be used. The camera sensor 43 processes the captured image data to acquire the shape of the target object, the relative distance between the vehicle VH and the target object, the relative speed, and the like.

The external sensor device 40 transmits the acquired target object data to ECU 10 at a predetermined cycle. Note that the external sensor device 40 does not necessarily have to include all of the radar sensor 41, the sonar sensor 42, and the camera sensor 43, and may include, for example, only the camera sensor 43.

HMI60 is an interface for inputting and outputting data between ECU 10 and drivers, and includes an input device and an output device. Examples of the input device include a touch panel type liquid crystal display, a switch, and a sound pickup microphone. Examples of the output device include a display device 61 and a speaker 62. The display device 61 is, for example, a center display, a multi-information display, or the like. The speaker 62 is, for example, a speaker of an acoustic system or a navigation system.

The automated parking switch 70 is, for example, a switch provided in a center console, an instrument panel, or the like of the vehicle VH and ON operated by an occupant (for example, a driver) of the vehicle VH. When the automated parking switch 70 is turned ON, ECU 10 receives the automatic parking start request. Note that the automated parking switch 70 is not limited to the physical switch, and may be a touch-type switch image displayed on the display device 61. In addition, the automatic parking start request may be acquired by voice recognition using a voice collection microphone or may be acquired by gesture recognition using a driver camera.

### Software Configuration

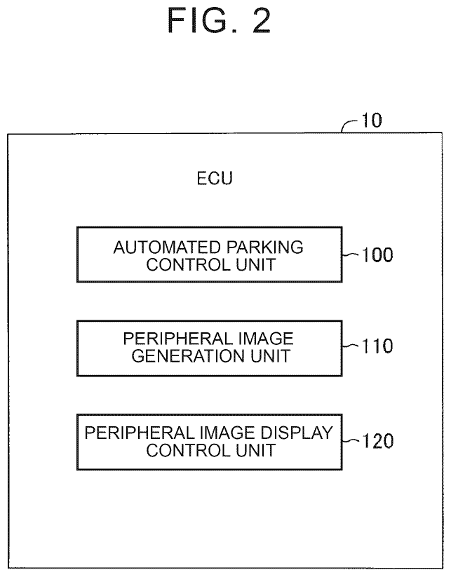

FIG. 2 is a schematic diagram illustrating a software configuration of ECU 10 according to the present embodiment. As illustrated in FIG. 2, ECU 10 includes an automated parking control unit 100, a peripheral image generation unit 110, a peripheral image display control unit 120, and the like as functional elements. These functional elements 100 to 120 are realized by CPU 11 of ECU 10 reading a program stored in ROM 12 into a RAM 13 and executing the program. Note that all or a part of the functional elements 100 to 120 may be provided in another ECU separate from ECU 10 or in an information processing device of a facility (e.g., a control center) capable of communicating with the vehicle VH.

The automated parking control unit 100 executes automatic parking control that causes the vehicle VH to travel along the target travel route to automatically enter or exit the vehicle VH into a predetermined parking compartment or from the predetermined parking compartment. Note that the automated parking control is basically the same process between the case where the vehicle VH is stored and the case where the vehicle VH is unloaded, and therefore, the case where the vehicle VH is stored will be described below, and the case where the vehicle is unloaded will be omitted.

The automated parking control unit 100 detects a parking compartment (hereinafter referred to as a parking compartment) in which the vehicle VH can be stored in the vicinity of the vehicle VH based on the target object information transmitted from the external sensor device 40. The automated parking control unit 100 detects a parkable section and displays the parkable section on the display device 61 when the driver ON the automated parking switch 70. When a plurality of parkable sections are detected, the automated parking control unit 100 displays the plurality of parkable sections on the display device 61. When the driver selects a specific parkable section by, for example, touching the screen of the display device 61, the automated parking control unit 100 sets the parkable section to the target parking section. The driver may be selected by an operation of a dial switch provided in a center console or the like. Alternatively, the selection of the driver may be obtained based on voice recognition by a voice pickup microphone or the like.

When the target parking space is set, the automated parking control unit 100 displays a selection screen of the parking mode on the display device 61. Here, examples of the parking mode include reverse parallel parking, forward parallel parking, reverse vertical train parking, and forward vertical train parking. The selection of the parking mode may be any one of a touch operation, a dial operation, and a voice recognition as in the above-described selection of the parkable section. Hereinafter, a case where the driver selects reverse parallel parking as the parking mode will be described as an example.

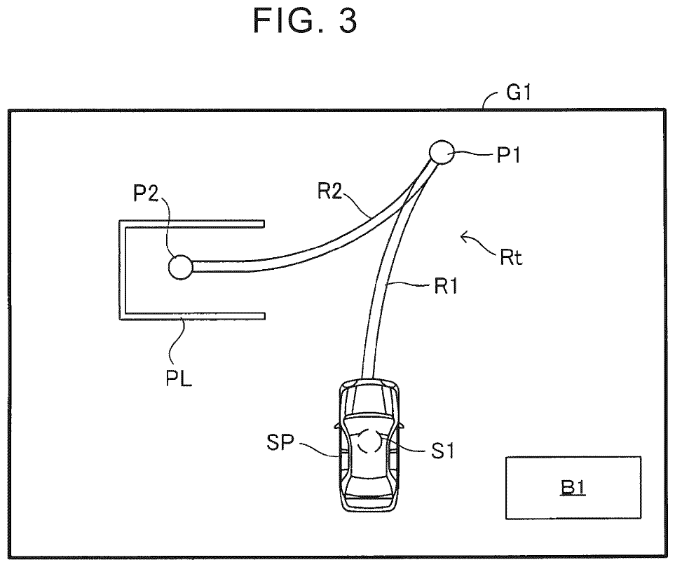

When reverse parallel parking is selected, the automated parking control unit 100 sets a target moving path for storing the vehicle VH in the target parking compartment. FIG. 3 illustrates an exemplary target moving path Rt set by the automated parking control unit 100. The target moving path Rt includes a forward path R1 for causing the vehicle VH to travel forward (forward control of the present disclosure) from the parking starting position S1, and a turning position P1 for stopping the vehicle VH (stop control of the present disclosure) and switching the traveling direction from forward to reverse. Further, the target moving path Rt includes: a reverse path R2 for causing the vehicle VH to travel backward (reverse control of the present disclosure) from the turning position P1; and a target stopping position P2 for stopping the vehicle VH at a predetermined position in the target parking space PL.

When the target moving path Rt is set, the automated parking control unit 100 displays a confirmation display G1 (shown in FIG. 3) including the target moving path Rt on the display device 61. The automated parking control unit 100 starts the automatic parking control when the driver touches the start-button B1 of the confirmation display G1. Automatic parking control is performed by, for example, feedback-controlling the operation of the drive device 20, the steering device 21, or the like based on the deviation between the target moving path Rt and the actual movement trajectory of the vehicle VH. The actual moving trajectory of the vehicle VH may be acquired, for example, by odometry based on the detection results of the vehicle speed sensor 31 and the steering angle sensor 34. The actual moving trajectory of the vehicle VH may be acquired by, for example, an optical flow based on road surface images or the like of the surroundings of the vehicle VH captured by the camera sensor 43. Note that the start command of the driver is not limited to the touch operation, and may be a dial operation, voice recognition, or the like.

The peripheral image generation unit 110 generates a peripheral image of the vehicle VH (hereinafter, referred to as a peripheral image) based on the target object information transmitted from the external sensor device 40. The peripheral image is an image corresponding to at least a part of the area around the vehicle VH, and includes a camera-viewpoint image, a composite image, and the like. The camera viewpoint image is an image in which an arrangement position of each lens of the camera sensor 43 is set as a viewpoint. One of the composite images is an image (hereinafter, referred to as a virtual viewpoint image) obtained by viewing the surroundings of the vehicle VH from a virtual viewpoint set at any position around the vehicle VH.

This method of generating a virtual viewpoint image is well known (see, for example, Japanese Unexamined Patent Application Publication No. 2012-217000 (JP 2012-217000 A), Japanese Unexamined Patent Application Publication No. 2016-192772 (JP 2016-192772 A), and Japanese Unexamined Patent Application Publication No. 2018-107754 (JP 2018-107754 A)). The peripheral image generation unit 110 further generates a video obtained by synthesizing (superimposing) a vehicle image (for example, a polygon indicating the shape of the vehicle VH), a graphic image constituting a line or the like that supports the parking operation, and the like with respect to each of the camera viewpoint video and the virtual viewpoint video.

An outline of a method for generating a virtual viewpoint image will be briefly described. The peripheral image generation unit 110 projects the pixels included in the front image, the rear image, the left side image, and the right side image captured by the camera sensor 43 onto a predetermined projection curved surface (for example, a hemispherical curved surface) in a virtual three-dimensional space. The center of the projected curved surface is defined as the position of the vehicle VH. A portion other than the center of the projection curved surface corresponds to the front image, the rear image, the left side image, and the right side image. The peripheral image generation unit 110 projects the information of the pixels included in the front image, the rear image, the left side image, and the right side image on a portion other than the center of the projection curved surface. The peripheral image generation unit 110 disposes the polygon representing the shape of the vehicle VH at the center of the projected curved surface. Then, the peripheral image generation unit 110 sets a virtual viewpoint in the virtual three-dimensional space, and cuts out a predetermined region of the projection curved surface included in the predetermined viewing angle as an image (video) from the virtual viewpoint. Further, polygons representing the shapes of the vehicle VH included in the predetermined viewing angle viewed from the virtual viewpoint are superimposed on the cut-out images (videos). As a result, a virtual viewpoint image is generated.

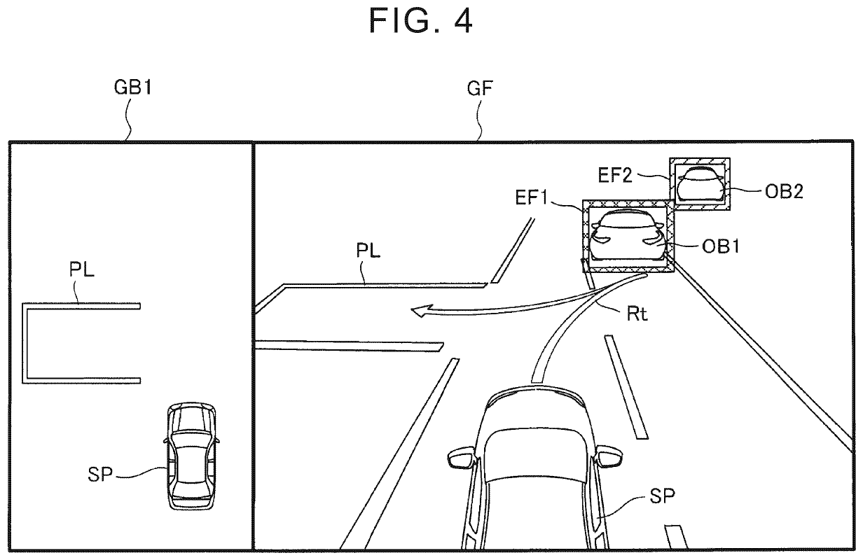

FIG. 4 is a schematic diagram illustrating a first bird's-eye view image GB1 generated by the peripheral image generation unit 110 and a camera viewpoint image (hereinafter, a front camera viewpoint image) GF in front of the vehicle VH.

The first bird's-eye view image GB1 is a virtual viewpoint image obtained by cutting out an area in a projection curved surface included in a predetermined viewing angle when the projection curved surface is viewed from a virtual viewpoint set directly above the vehicle VH. In the first bird's-eye view image GB1, the polygon SP of the vehicle VH, the target parking space PL, and the like are superimposed and displayed. The front camera viewpoint image GF is a video captured mainly by the front camera sensor of the camera sensor 43. In the front camera viewpoint image GF, the polygon SP of the vehicle VH, the target moving path Rt, the target parking space PL, the obstacle emphasis markings EF1, EF2, and the like are superimposed and displayed. The obstacle emphasis markings EF1, EF2 are figures surrounding obstacles OB1, OB2 of another vehicle or the like in front of the vehicle VH detected by the external sensor device 40.

The peripheral image generation unit 110 displays the obstacle emphasis marking EF1 of the obstacle OB1 having a large effect that the predicted trajectory intersects the target moving path Rt among the obstacles in a first color (for example, red) that prompts the drivers to pay attention. In addition, the peripheral image generation unit 110 displays the obstacle emphasis marking EF2 of the obstacle OB2 having a smaller effect that the predicted trajectory does not intersect the target moving path Rt among the obstacles in a second color (for example, amber color) that is lighter in color than the first color.

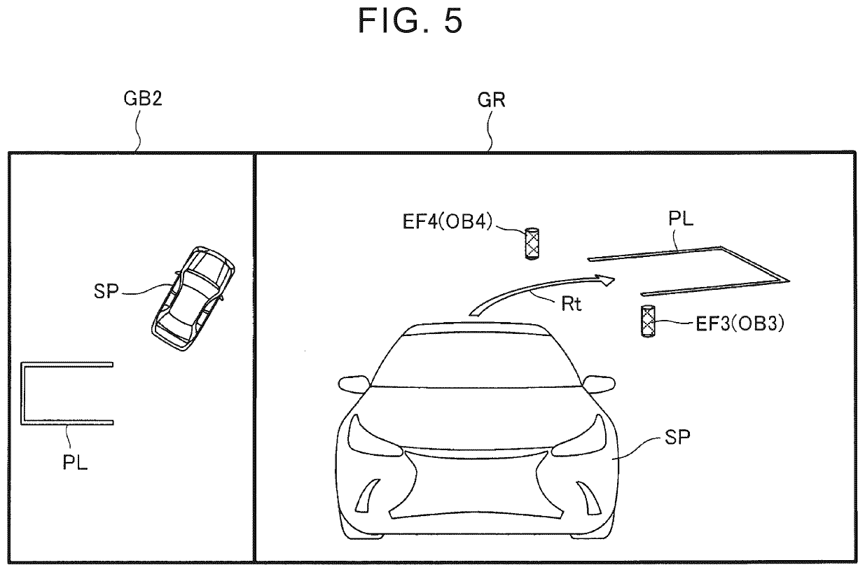

FIG. 5 is a schematic diagram for describing the second bird's-eye view image GB2 generated by the peripheral image generation unit 110 and the camera viewpoint image (hereinafter, rear camera viewpoint image) GR on the rear side of the vehicle VH.

In the second bird's-eye view image GB2, the polygon SP of the vehicle VH, the target parking space PL, and the like are displayed in a superimposed manner, similar to the first bird's-eye view image GB1 described above. The rear camera viewpoint image GR is a video captured mainly by the rear camera sensor of the camera sensor 43. In the rear camera viewpoint image GR, the polygon SP of the vehicle VH, the target moving path Rt, the target parking space PL, the obstacle emphasis markings EF3, EF4, and the like are superimposed and displayed. The obstacle emphasis markings EF3, EF4 are a figure or the like superimposed on obstacles OB3, OB4 such as a pole on the rear of the vehicle VH detected by the external sensor device 40. The peripheral image generation unit 110 extracts obstacles OB3, OB4 existing within a predetermined distance from the target moving path Rt among the obstacles, and superimposes the obstacle emphasis markings EF3, EF4 on the extracted obstacles OB3, OB4. The colors of the obstacle emphasis markings EF3, EF4 may all be the same color or may be changed in accordance with the distance from the target moving path Rt.

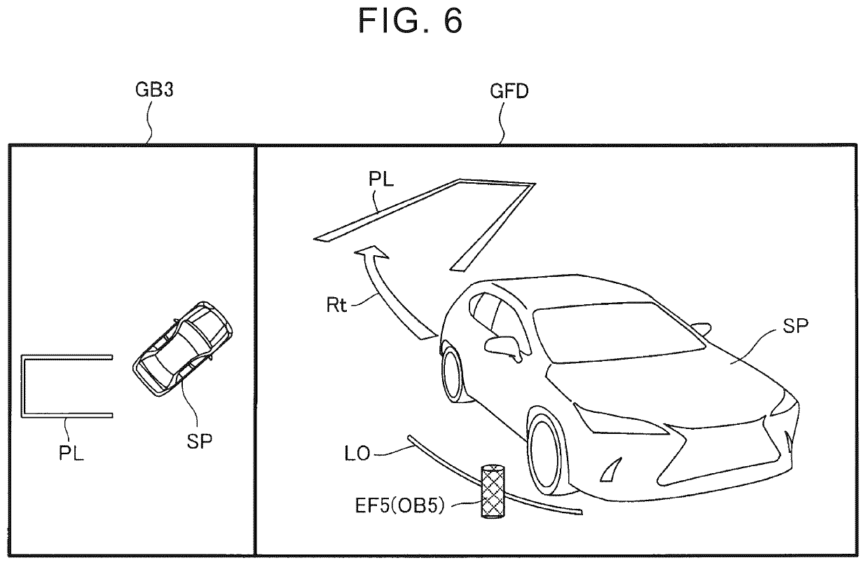

FIG. 6 is a schematic diagram for describing a third bird's-eye view image GB3 generated by the peripheral image generation unit 110 and a virtual viewpoint image (hereinafter, referred to as a right-diagonally-front upper virtual viewpoint image) GFD in which the vehicle VH is viewed from above in the right-diagonally front.

In the third bird's-eye view image GB3, the polygon SP of the vehicle VH, the target parking space PL, and the like are superimposed and displayed, similarly to the first bird's-eye view image GB1 and the like described above. The right-diagonally-front upper virtual viewpoint image GFD is a virtual viewpoint image obtained by cutting out an area in a projection curved surface included in a predetermined viewing angle by looking at the projection curved surface from a virtual viewpoint set above the right obliquely front of the vehicle VH. Note that the virtual viewpoint image obtained by viewing the vehicle VH from the upper left-obliquely front side is obtained by inverting the left and right of the right-diagonally-front upper virtual viewpoint image GFD, and therefore will not be described. In the right-diagonally-front upper virtual viewpoint image GFD, the polygon SP of the vehicle VH, the target moving path Rt, the target parking space PL, the obstacle emphasis marking EF5, the predicted turning outer passing line LO, and the like are superimposed and displayed.

The predicted turning outer passing line LO is a line indicating a part (border) of an area through which the vehicle body of the vehicle VH passes, which is predicted to protrude to the turning outer most. The obstacle emphasis marking EF5 is a figure or the like superimposed on an obstacle OB5 such as a pole or the like present on the turning outer side of the vehicle VH detected by the external sensor device 40. The peripheral image generation unit 110 extracts an obstacle OB5 existing within a predetermined distance from the predicted turning outer passing line LO among the obstacles, and superimposes the obstacle emphasis marking EF5 on the extracted obstacle OB5.

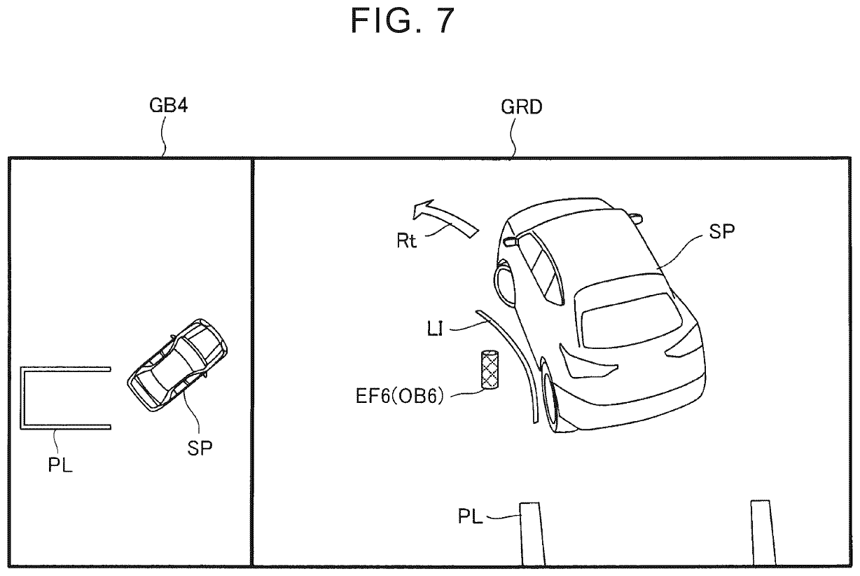

FIG. 7 is a schematic diagram illustrating a fourth bird's-eye view image GB4 generated by the peripheral image generation unit 110 and a virtual viewpoint image (hereinafter, referred to as a left-diagonally-rear upper virtual viewpoint image) GRD obtained by viewing the vehicle VH from the upper left-diagonally rearward direction.

In the fourth bird's-eye view image GB4, the polygon SP of the vehicle VH, the target parking space PL, and the like are superimposed and displayed, similarly to the first bird's-eye view image GB1 and the like described above. The left-diagonally-rear upper virtual viewpoint image GRD is a virtual viewpoint image obtained by cutting out an area in a projection curved surface included in a predetermined viewing angle when the projection curved surface is viewed from a virtual viewpoint set above the left oblique rear of the vehicle VH. Note that the virtual viewpoint image obtained by viewing the vehicle VH from the upper side of the right obliquely rear side is obtained by inverting the left and right of the left-diagonally-rear upper virtual viewpoint image GRD, and therefore will not be described. In the left-diagonally-rear upper virtual viewpoint image GRD, the polygon SP of the vehicle VH, the target moving path Rt, the target parking space PL, the obstacle emphasis marking EF6, the predicted turning inside passing line LI, and the like are superimposed and displayed.

The predicted turning inner passing line LI is a line indicating a part (border) of an area through which the vehicle body of the vehicle VH passes, which is predicted to protrude most toward the turning inner side. The obstacle emphasis marking EF6 is a figure or the like superimposed on an obstacle OB6 such as a pole or the like existing inside the turning of the vehicle VH detected by the external sensor device 40. The peripheral image generation unit 110 extracts obstacle OB6 existing within a predetermined distance from the predicted turning inner passing line LI among obstacles, and superimposes the obstacle emphasis marking EF6 on the extracted obstacle OB6.

Referring again to FIG. 2, during execution of the automatic parking control by the automated parking control unit 100, the peripheral image display control unit 120 executes peripheral image display control for appropriately displaying the image generated by the peripheral image generation unit 110 on the display device 61 in accordance with the progress of the automatic parking control. Hereinafter, specific details of the peripheral image display control will be described.

It is considered that the line of sight of the drivers is directed toward the front of the vehicle VH when the vehicle VH travels forward on the forward path R1 of the target moving path Rt from the parking starting position S1 to the turning position P1 by the automated parking control. The peripheral image display control unit 120 displays the front camera viewpoint image GF and the first bird's-eye view image GB1 (see FIG. 4) generated by the peripheral image generation unit 110 on the display device 61 while the vehicle VH travels on the forward path R1 by the automated parking control (forward control). At this time, the front camera viewpoint image GF may expand the display area as the vehicle speed of the vehicle VH increases, and reduce the display area as the vehicle speed of the vehicle VH decreases.

As described above, while the vehicle VH travels forward by the automated parking control, the front camera viewpoint image GF is displayed on the display device 61. Accordingly, the driver can appropriately grasp the presence of an obstacle OB1 that may affect the travel of the vehicle VH and the presence of an obstacle OB2 that does not affect the travel of the vehicle VH from the front camera viewpoint image GF. That is, the driver can easily determine whether to continue the autonomous parking during the forward travel of the vehicle VH.

It is considered that the line of sight of the drivers is directed to the rear of the vehicle VH via a room mirror or the like when the vehicle VH reaches the turning position P1 by the automated parking control. When the vehicle VH stops at the turning position P1 by the automated parking control (stop control), the peripheral image display control unit 120 displays the rear camera viewpoint image GR generated by the peripheral image generation unit 110 and the second bird's-eye view image GB2 (see FIG. 5) on the display device 61. The timing of displaying the rear camera viewpoint image GR on the display device 61 (that is, the timing of switching from the front camera viewpoint image GF) may be a timing at which the vehicle VH reaches the turning position P1. Alternatively, the timing at which the rear camera viewpoint image GR is displayed on the display device 61 (that is, the timing at which the front camera viewpoint image GF is switched) may be a timing that is a predetermined time earlier than the timing at which the vehicle VH reaches the turning position P1.

In this way, when the vehicle VH is stopped at the turning position P1 by the automated parking control, the rear camera viewpoint image GR is displayed on the display device 61. Accordingly, the driver can effectively grasp the situation behind the vehicle VH from the rear camera viewpoint image GR. That is, the driver can easily determine whether the driver may start the backward travel of the vehicle VH by the automated parking.

In some cases, the vehicle VH travels backward while turning from the turning position P1 to the target stopping position P2 on the reverse path R2 of the target moving path Rt by the automatic parking control. In this case, it is considered that the line of sight of the driver is directed to the side of the vehicle VH (the inside of the turning or the outside of the turning) via a side mirror or the like. The peripheral image display control unit 120 displays, on the display device 61, the right-diagonally-front upper virtual viewpoint image GFD and the third bird's-eye view image GB3 (see FIG. 6) or the left-diagonally-rear upper virtual viewpoint image GRD and the fourth bird's-eye view image GB4 (see FIG. 7, however, the target moving path Rt is set to the reverse direction) generated by the peripheral image generation unit 110 while the vehicle VH travels while turning on the reverse path R2 by the automatic parking control (reverse control).

When the distance between the predicted turning outer passing line LO and the obstacle OB5 is closer than the distance between the predicted turning inner passing line LI and the obstacle OB6, the peripheral image display control unit 120 displays the right-diagonally-front upper virtual viewpoint image GFD and the third bird's-eye view image GB3 on the display device 61. On the other hand, when the distance between the predicted turning inside passing line L1 and the obstacle OB6 is closer than the distance between the predicted turning outside passing line LO and the obstacle OB5, the peripheral image display control unit 120 displays the left-diagonally-rear upper virtual viewpoint image GRD and the fourth bird's-eye view image GB4 on the display device 61.

As described above, while the vehicle VH travels backward by the automated parking control, the right-diagonally-front upper virtual viewpoint image GFD or the left-diagonally-rear upper virtual viewpoint image GRD is displayed on the display device 61. As a result, the driver can appropriately grasp whether the vehicle VH can slip through without touching the obstacles OB5, OB6 from the right-diagonally-front upper virtual viewpoint image GFD or the left-diagonally-rear upper virtual viewpoint image GRD. That is, the driver can easily determine whether to continue the automated parking while the vehicle VH is traveling backward.

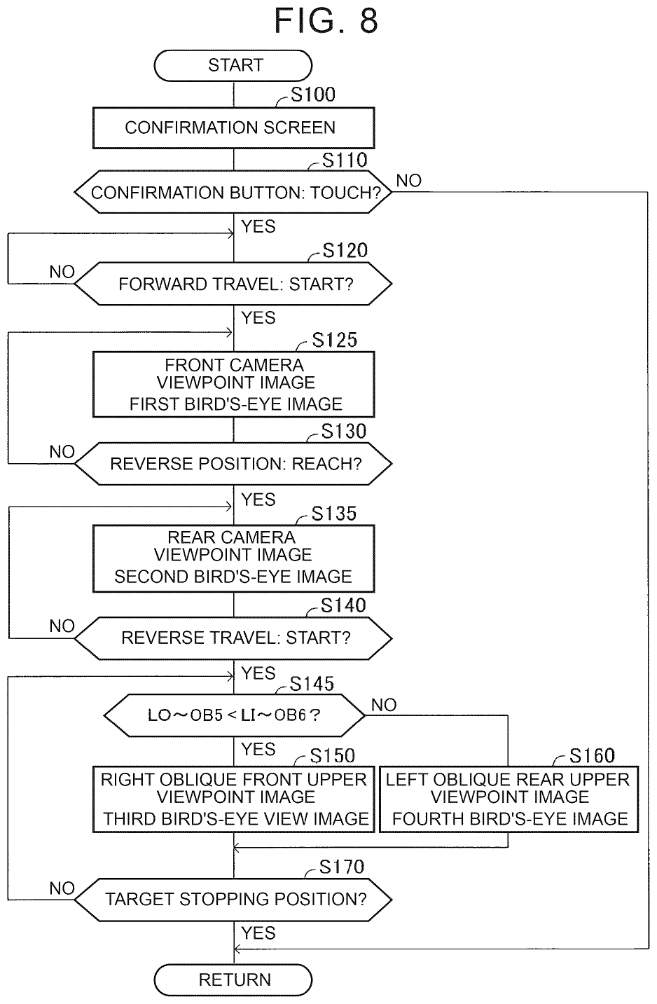

Next, based on the flow chart shown in FIG. 8, a routine of a peripheral image displaying control process executed by CPU 11 of ECU 10 will be described. The routine is initiated after the driver performs an ON operation of the automated parking switch 70 and selects the target parking compartment and the parking mode. In the following description, for convenience, a situation will be described in which, as the parking mode, the driver selects reverse parallel parking in which the driver moves backward while turning leftward from the turning position P1 toward the target stopping position P2, and the driver does not cancel the autonomous parking until the vehicle VH reaches the target stopping position P2.

In S100, ECU 10 displays a confirmation display G1 (see FIG. 3) including the target moving path Rt and the start-button B1 on the display device 61. Then, in S110, ECU 10 determines whether the driver has touched the start-button B1. When the driver touches the start-button B1 (Yes), ECU 10 proceeds to S120 process. On the other hand, if the driver does not touch the start-button B1 (No), ECU 10 returns.

In S120, ECU 10 determines whether the vehicle VH starts traveling on the forward path R1 by the automated parking control. Whether or not the traveling of the forward path R1 has started may be determined based on the detection result of the vehicle speed sensor 31 or the shift sensor 35. When the vehicle VH starts traveling in the forward path R1 (Yes), ECU 10 proceeds to S125 process. On the other hand, when the vehicle VH does not begin traveling in the forward path R1 (No), ECU 10 returns to S120 process.

In S125, ECU 10 displays the front camera viewpoint image GF and the first bird's-eye view image GB1 (see FIG. 4) on the display device 61. At this time, the front camera viewpoint image GF may expand the display area as the vehicle speed of the vehicle VH increases, and reduce the display area as the vehicle speed of the vehicle VH decreases.

Then, in S130, ECU 10 determines whether the vehicle VH has reached the turning position P1 by the automated parking control. Whether or not the turning position P1 has been reached may be determined based on the detection result of the vehicle speed sensor 31 or the shift sensor 35. If the vehicle VH reaches the turning position P1 (Yes), ECU 10 proceeds to S135 process. On the other hand, if the vehicle VH does not reach the turning position P1 (No), ECU 10 returns to S125 process.

In S135, ECU 10 displays the rear camera viewpoint image GR and the second bird's-eye view image GB2 (see FIG. 5) on the display device 61.

Then, in S140, ECU 10 determines whether the vehicle VH starts traveling in the reverse path R2 by the automated parking control. Whether or not the traveling of the reverse path R2 has started may be determined based on the detection result of the vehicle speed sensor 31 or the shift sensor 35. When the vehicle VH starts traveling in the reverse path R2 (Yes), ECU 10 proceeds to S145 process. On the other hand, when the vehicle VH does not begin traveling in the reverse path R2 (No), ECU 10 returns to S135 process.

In S145, ECU 10 determines whether or not the distance between the predicted turning outer passing line LO and the obstacle OB5 is closer than the distance between the predicted turning inner passing line L1 and the obstacle OB6. When the distance between the predicted turning outer passing line LO and the obstacle OB5 is closer than the distance between the predicted turning inner passing line L1 and the obstacle OB6 (Yes), ECU 10 proceeds to S150 process and displays the right-diagonally-front upper virtual viewpoint image GFD and the third bird's-eye view image GB3 (see FIG. 6) on the display device 61. On the other hand, ECU 10 proceeds with the process to S160 when and displays the left-diagonally-rear upper virtual viewpoint image GRD and the fourth bird's-eye view image GB4 (see FIG. 7, but with the target moving path Rt set to the reverse direction) on the display device 61 when the distance between the predicted turning outer passing line LO and the obstacle OB5 is not closer than the distance between the predicted turning inner passing line L1 and the obstacle OB6 (No), that is, when the distance between the predicted turning inner passing line L1 and the obstacle OB6 is closer than the distance between the predicted turning outer passing line LO and the obstacle OB5.

In S170, ECU 10 determines whether the vehicle VH has reached the target stopping position P2 by the automated parking control. If the vehicle VH does not reach the target stopping position P2 (No), ECU 10 returns to S145 process. On the other hand, when the vehicle VH reaches the target stopping position P2 (Yes), ECU 10 returns (ends).

It should be noted that the present disclosure is not limited to the above-described embodiments, and various modifications can be made without departing from the scope of the present disclosure.

For example, in the above embodiment, the automatic parking control has been described as an example of a so-called route setting type automatic parking for setting a target moving path Rt, but the disclosed technology can also be applied to a so-called route storage type automatic parking used when a driver manually parks a vehicle VH and parks the movement route in the same parking compartment from the next time onward. The technology of the present disclosure can also be applied to an autonomous vehicle that automatically performs some or all of the driving operations.

What is claimed is:

1. A vehicle surrounding video display device configured to display a surrounding video around a vehicle configured to execute automatic parking control for causing the vehicle to automatically enter a predetermined parking slot or automatically leave the parking slot, the vehicle surrounding video display device comprising:
a video generator configured to generate a plurality of surrounding videos having different viewpoints based on an image captured by a camera mounted on the vehicle; and
a video display controller configured to select a surrounding video corresponding to progress of the automatic parking control from among the plurality of surrounding videos generable by the video generator during execution of the automatic parking control, and display the surrounding video on a display device of the vehicle.

2. The vehicle surrounding video display device according to claim 1, further comprising
an obstacle detector configured to detect an obstacle present around the vehicle, wherein the video generator is configured to
when the obstacle is detected by the obstacle detector, generate, as the surrounding video, a video in which the obstacle is emphasized.

3. The vehicle surrounding video display device according to claim 1, wherein the video display controller is configured to
when forward travel control for causing the vehicle to travel forward to a predetermined turn position, stop control for stopping the vehicle at the turn position, and reverse travel control for causing the vehicle to travel in reverse from the turn position to a predetermined position in the parking slot are executed as the automatic parking control,
display different surrounding videos on the display device during execution of the forward travel control, during execution of the stop control, and during execution of the reverse travel control.

4. The vehicle surrounding video display device according to claim 3, wherein:
the video generator is configured to
generate, as the plurality of surrounding videos, a front viewpoint video obtained by imaging a front area from the vehicle, a rear viewpoint video obtained by imaging a rear area from the vehicle, and an obliquely upper viewpoint video obtained by viewing the vehicle obliquely from above; and
the video display controller is configured to
display, on the display device, the front viewpoint video during the execution of the forward travel control, the rear viewpoint video during the execution of the stop control,
and the obliquely upper viewpoint video during the execution of the reverse travel control.

5. The vehicle surrounding video display device according to claim 4, wherein the video generator is configured to
generate, as the obliquely upper viewpoint video, a video obtained by superimposing a predicted passing line indicating a boundary of an area that a vehicle body of the vehicle is predicted to pass through by the reverse travel control.
